(19) United States
(12) Patent Application Publication
(10) Pub. No.: US 2026/0091458 A1
(43) Pub. Date: Apr. 2, 2026

(54) CONTROLLING TRAJECTORY OF METAL CHIP FLOW DURING METAL CUTTING OPERATION

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Katupakkam (IN)

(21) Appl. No.: 18/903,008

(22) Filed: Oct. 1, 2024

(51) Int. Cl. B23Q 11/00; G05B 19/418

(52) U.S. Cl. CPC B23Q 11/0064; G05B 19/41865; G05B 19/41885

(57) ABSTRACT

Examples described herein provide for controlling the trajectory of metal chips during a metal cutting operation. Aspects include determining a predicted metal chip formation pattern during the metal cutting operation of a workpiece. Prior to the initiation of the metal cutting operation, the system sets the orientation of the workpiece, and the cutting tool based on the predicted metal chip formation pattern. During the metal cutting operation, the system observes the actual metal chip formation pattern and adjusts the orientation of the workpiece and the cutting tool to control the trajectory of the metal chips, preventing them from contacting the finished portion of the workpiece. Aspects may also involve controlling an electromagnet to create a magnetic field to adjust the trajectory of the metal chips and determining the direction and speed of a cutting fluid applied by the cutting tool based on the predicted and actual metal chip formation patterns.

### BACKGROUND

The discourse relates generally to control systems for metal cutting operations and more specifically to controlling the trajectory of metal chip flow during metal cutting operation.

During metal cutting operations, various types of metal fragments are generated. The basic types of fragments produced in metal cutting include continuous fragments, discontinuous fragments, continuous fragments with built-up edges, and serrated fragments. When metal fragments come into contact with the finished workpiece during machining, several problems can occur. Metal fragments can scratch and damage the surface finish of the workpiece. Heavy contact with metal fragments can cause localized deformation of the workpiece, compromising the dimensional accuracy and structural integrity of the workpiece. The metal fragments rubbing against the finished surface can accelerate tool wear, reducing tool lifespan and potentially causing inaccuracies in subsequent machining operations.

Existing solutions such as cutting fluid and fragment removal methods are available, but fragments might still contact the finished workpiece, necessitating a method and system to prevent fragment contact with the workpiece.

### SUMMARY

According to one aspect of the present invention, a computer-implemented method for controlling a trajectory of metal chips during a metal cutting operation includes determining a predicted metal chip formation pattern during the metal cutting operation of a workpiece, setting, prior to initiation of the metal cutting operation, an orientation of the workpiece and a cutting tool based on at least in part on the predicted metal chip formation pattern. The method also includes initiating the metal cutting operation of the workpiece by the cutting tool, observing, during the metal cutting operation, an actual metal chip formation pattern, and changing the orientation of the workpiece and the cutting tool based on at least in part on the actual metal chip formation pattern, where the orientation of the workpiece and the cutting tool are configured to control the trajectory of the metal chips to prevent the metal chips from contacting a finished portion of the workpiece.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of metal cutting tool and a control system for operating the metal cutting tool, according to one or more embodiments;

FIG. 3A illustrates a system for controlling the trajectory of metal chips during a metal cutting operation, according to one or more embodiments;

FIG. 3B illustrates a portion of a system for controlling the trajectory of metal chips during a metal cutting operation, according to one or more embodiments;

FIG. 3C illustrates a system for controlling the trajectory of metal chips during a metal cutting operation, according to one or more embodiments;

FIG. 3D illustrates a system for controlling the trajectory of metal chips during a metal cutting operation using an electromagnet to generate an electromagnetic field, according to one or more embodiments; and

FIG. 4 illustrates a flow chart diagram of another method for controlling a trajectory of metal chips during a metal cutting operation, according to one or more embodiments.

The detailed description explains embodiments of the disclosure, together with advantages and features, by way of example with reference to the drawings.

### DETAILED DESCRIPTION

During metal cutting operations, various types of metal fragments are generated. These fragments, often referred to as chips, can take several forms, including continuous chips, discontinuous chips, continuous chips with built-up edges, and serrated chips. When these metal chips come into contact with the finished workpiece during machining, several problems can occur. Metal chips can scratch and damage the surface finish of the workpiece. Heavy contact with metal chips can cause localized deformation of the workpiece, compromising the workpiece's dimensional accuracy and structural integrity. The metal chips rubbing against the finished surface can accelerate tool wear, reducing tool lifespan and potentially causing inaccuracies in subsequent machining operations.

Existing solutions such as cutting fluid and chip removal methods are available, but chips might still contact the finished workpiece. Cutting fluids are often used to cool and lubricate the cutting process, but they do not prevent chips from making contact with the workpiece. Chip removal methods, such as mechanical chip conveyors or vacuum systems, can help to some extent, but they are not effective in preventing chips from touching the finished surface. These methods can also be cumbersome and may not adapt well to different machining conditions, leading to inefficiencies and potential damage to the workpiece.

The disclosed method and system address these issues by providing a computer-implemented method for controlling the trajectory of metal chips during a metal cutting operation. The method includes determining a predicted metal chip formation pattern during the metal cutting operation of a workpiece. Prior to the initiation of the metal cutting operation, the system sets the orientation of the workpiece and the cutting tool based on the predicted metal chip formation pattern. During the metal cutting operation, the system observes the actual metal chip formation pattern and dynamically adjusts the orientation of the workpiece and the cutting tool to control the trajectory of the metal chips, preventing them from contacting the finished portion of the workpiece. This approach ensures precise and damage-free machining by dynamically adapting to the real-time conditions of the cutting process.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

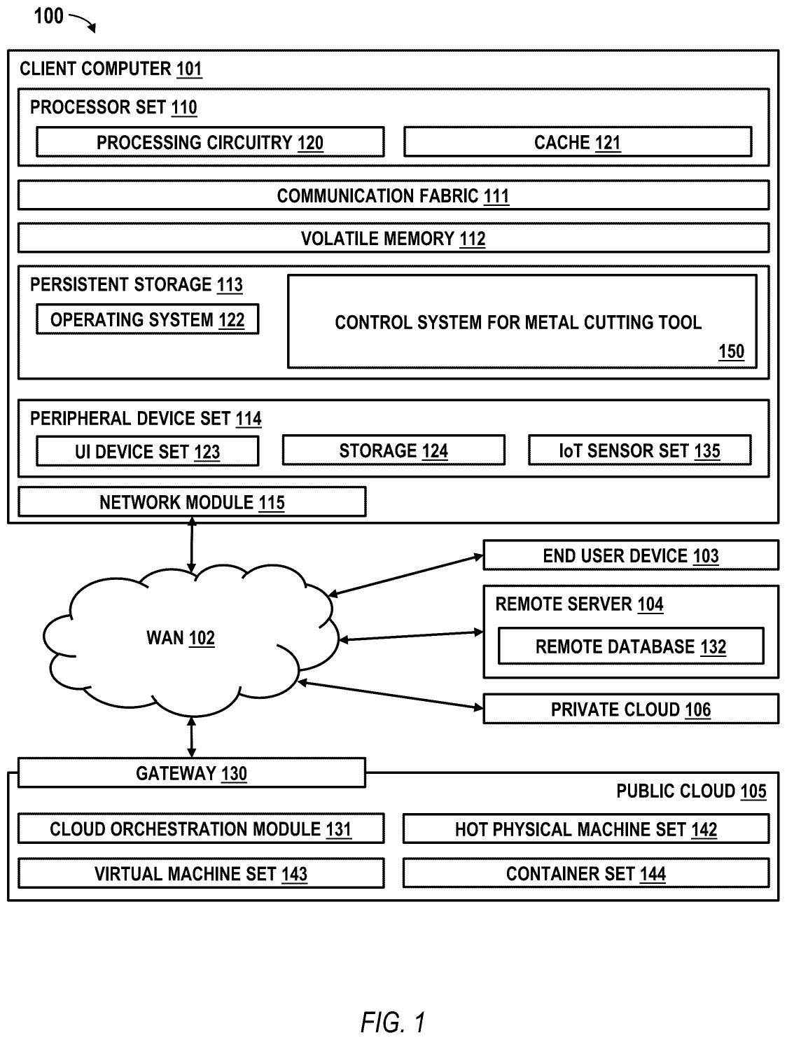

FIG. 1 illustrates a computing environment 100, according to an embodiment. Computing environment 100 contains an example of an environment for the execution of at least some of the computer code involved in performing the inventive methods, such as controlling the operations of a metal cutting tool, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

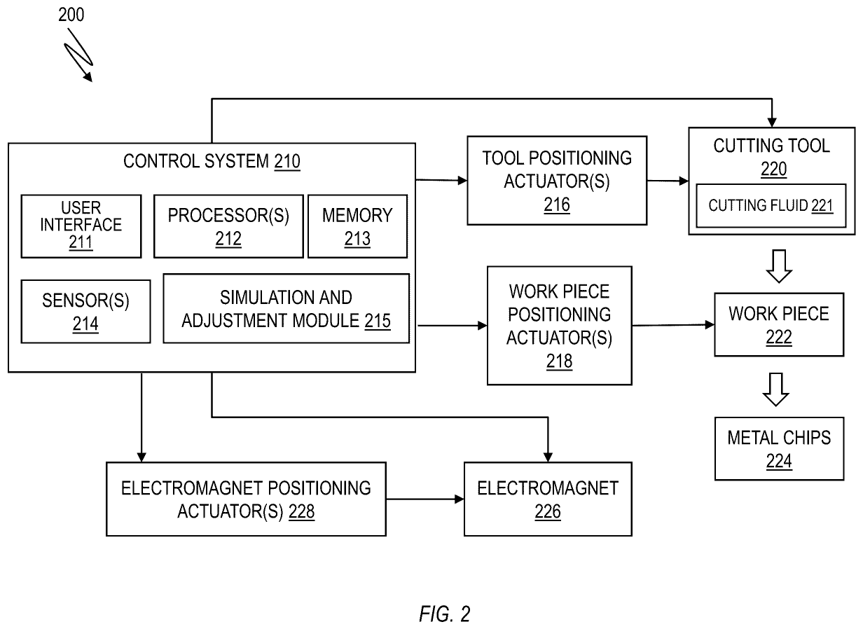

Referring now to FIG. 2, a block diagram of a system 200 for controlling the trajectory of metal chip flow during metal cutting operation. The system 200 includes a control system 210 that is configured to control the operation of a cutting tool 220 and one or more actuators 216, 218. In exemplary embodiments, the control system 210 interfaces with various components to manage a metal cutting operation performed by a cutting tool 220 on a workpiece 222. The control system 210 receives input from the user interface 211 and processes data from the sensor(s) 214 to dynamically adjust the cutting tool 220 and one or more actuators 216, 218 during the cutting process. The control system 210 also communicates with the simulation and adjustment module 215 to predict and respond to metal chip formation patterns.

In exemplary embodiments, the user interface 211 allows operators to input parameters and monitor the status of the metal cutting operation. The user interface 211 provides real-time feedback and control options, enabling the operator to make necessary adjustments to the cutting process. The user interface 211 connects directly to the control system 210, facilitating seamless communication and control.

In exemplary embodiments, the processor(s) 212 executes the control algorithms and manages data processing tasks. The processor(s) 212 are responsible for running simulations, analyzing sensor data, and executing commands to adjust the cutting tool and workpiece alignment. The processor(s) 212 are connected to the memory 213, which stores the necessary software, historical data, and real-time data for the cutting operation.

In exemplary embodiments, the memory 213 stores the software and data required for the control system 210 to function. The memory 213 includes storage for historical data on chip formation patterns, cutting parameters, and workpiece specifications. The memory 213 also holds the real-time data collected by the sensor(s) 214, which the processor(s) 212 use to make dynamic adjustments during the cutting operation.

In exemplary embodiments, the sensor(s) 214 collects real-time data on various aspects of the cutting operation, including the position of the cutting tool, the workpiece, and the formation of metal chips. The sensor(s) 214 provides feedback to the control system 210, enabling the control system 210 to make precise adjustments to prevent metal chips from contacting the finished workpiece. The sensor(s) 214 are strategically placed to monitor parameters and ensure accurate data collection. Various types of sensors can be employed to collect comprehensive data on different aspects of the process. For instance, position sensors such as linear encoders and rotary encoders can be used to precisely measure the position and movement of the cutting tool and workpiece. These sensors provide accurate feedback on the alignment and orientation, enabling the control system to make necessary adjustments. Additionally, force sensors can be utilized to monitor the cutting forces exerted on the tool and workpiece. These sensors help in detecting any excessive forces that could lead to tool wear or workpiece deformation. Temperature sensors, such as thermocouples and infrared sensors, can be employed to measure the temperature at the cutting zone. Monitoring the temperature is essential for optimizing the application of cutting fluids and preventing overheating, which can affect the quality of the cut and the lifespan of the tool. Vibration sensors, including accelerometers, can be used to detect any abnormal vibrations during the cutting process. These sensors help in identifying issues related to tool chatter or instability, allowing for timely corrective actions. Furthermore, optical sensors, such as machine vision cameras, can be used to visually inspect the chip formation and trajectory. These cameras provide real-time images and videos that can be analyzed to ensure that the chips are being effectively removed and are not contacting the finished workpiece. By integrating these various types of sensors, the system can achieve a comprehensive and precise monitoring capability, ensuring optimal performance and quality in the metal cutting operation.

In exemplary embodiments, the simulation and adjustment module 215 predicts metal chip formation patterns and determines the optimal alignment of the cutting tool and workpiece. The simulation and adjustment module 215 uses historical data and real-time sensor input to simulate different cutting scenarios and adjust the cutting parameters accordingly. In exemplary embodiments, to predict metal chip formation patterns, the simulation and adjustment module 215 first collects historical data on various cutting operations. This data includes information on the types of materials being cut, the cutting tools used, the cutting parameters (such as speed, feed rate, and depth of cut), and the resulting chip formation patterns. This historical data serves as a foundation for training a machine learning model. The machine learning model is trained using supervised learning techniques, where the input features include the cutting parameters and material properties, and the output labels are the observed chip formation patterns. The model learns to recognize patterns and relationships between the input features and the resulting chip formations. Various machine learning algorithms, such as decision trees, support vector machines, or neural networks, can be employed to develop an accurate predictive model.

Once the machine learning model is trained, it can be integrated into the simulation and adjustment module 215. During a metal cutting operation, the module receives real-time data from the sensors 214, including the position and movement of the cutting tool and workpiece, the cutting forces, temperature, and vibrations. This real-time data is fed into the trained machine learning model, which predicts the metal chip formation patterns based on the current cutting conditions. The simulation and adjustment module 215 uses these predictions to simulate different cutting scenarios and determine the optimal alignment of the cutting tool and workpiece. For example, if the model predicts that the current cutting parameters will result in continuous chips that may contact the finished workpiece, the module can adjust the cutting speed, feed rate, or tool orientation to produce discontinuous chips that are easier to remove. The simulation and adjustment module 215 can also simulate the effects of different cutting fluid applications and chip removal strategies to ensure that the chips do not interfere with the finished surface. The simulation and adjustment module 215 communicates with the control system 210 to implement these adjustments in real-time. By continuously monitoring the real-time data and updating the predictions, the simulation and adjustment module 215 can dynamically adjust the cutting parameters to control the trajectory of the metal chips. This approach ensures precise and damage-free machining by adapting to the real-time conditions of the cutting process and preventing chips from contacting the finished workpiece.

In exemplary embodiments, the tool positioning actuator(s) 216 is configured to adjust the position and orientation of the cutting tool 220 based on commands from the control system 210. The tool positioning actuator(s) 216 ensures that the cutting tool 220 is aligned correctly to minimize chip contact with the finished workpiece. These actuators are capable of precise movements and adjustments, allowing for dynamic changes during the cutting operation.

In exemplary embodiments, the workpiece positioning actuator(s) 218 is configured to adjust the position and orientation of the workpiece 222. The workpiece positioning actuator(s) 218 works in conjunction with the tool positioning actuator(s) 216 to ensure optimal alignment and prevent chip contact with the finished surface. These actuators receive commands from the control system 210 and make real-time adjustments based on sensor data and simulation results.

In exemplary embodiments, the cutting tool 220 performs the actual cutting operation on the workpiece 222. The cutting tool 220 is controlled by the tool positioning actuator(s) 216 and is adjusted based on the predicted and actual chip formation patterns. The cutting tool 220's orientation and movement ensure that metal chips do not contact the finished workpiece. A wide variety of cutting tools 220 may be utilized. These cutting tools 220 can be categorized based on their cutting action, material, and the type of machining operation they perform. Additionally, some cutting tools are designed to use cutting fluids 221 to enhance their performance and extend their lifespan. Turning tools, for instance, are used in lathes to remove material from the outer diameter of a rotating workpiece and can be made from high-speed steel (HSS), carbide, or ceramic materials. Cutting fluids 221 are often applied to turning tools to reduce heat, improve surface finish, and extend tool life. Milling cutters, used in milling machines, include end mills, face mills, slab mills, and ball nose cutters, and they often use cutting fluids to cool the cutting zone, reduce friction, and flush away chips. Drills, such as twist drills and spade drills, create holes in a workpiece and frequently use cutting fluids to lubricate the cutting edges, reduce heat, and prevent chip clogging. Reamers, which enlarge and finish existing holes, and taps, which create internal threads, also benefit from cutting fluids to improve surface finish, reduce tool wear, and remove chips. Broaches, used to create precise shapes in a single pass, grinding wheels, used for abrasion, and saw blades, used for cutting workpieces, all utilize cutting fluids to reduce heat, improve performance, and extend tool life. Inserts, which are replaceable cutting edges used in various tools, also benefit from cutting fluids to enhance cutting performance and reduce wear. By selecting the appropriate cutting tool and applying cutting fluids, machinists can achieve precise and efficient metal cutting operations.

In exemplary embodiments, the workpiece 222 is the material being machined by the cutting tool 220. The workpiece 222's position and orientation are adjusted by the workpiece positioning actuator(s) 218 to optimize the cutting process and prevent chip contact. The workpiece 222's dimensions and material properties are considered by the control system 210 and the simulation and adjustment module 215 to determine the cutting strategy.

In exemplary embodiments, the metal chips 224 are the byproducts of the cutting operation. The control system 210, along with the simulation and adjustment module 215, predicts the formation and trajectory of the metal chips 224 to prevent them from contacting the finished workpiece. The system dynamically adjusts the cutting parameters to control the flow of metal chips 224.

In exemplary embodiments, the prediction of the formation and trajectory of metal chips during metal cutting operations is a complex process that involves understanding the types of chips generated, the forces acting on them, and their resulting movement. In general, metal chips can be categorized into several types, including continuous chips, discontinuous chips, continuous chips with built-up edges, and serrated chips. Continuous chips are long and ribbon-like, formed when cutting ductile materials at high speeds. Discontinuous chips are short and segmented, typically produced when cutting brittle materials or at low speeds. Continuous chips with built-up edges occur when material adheres to the cutting tool, causing irregular chip formation. Serrated chips have a saw-tooth appearance and are formed during the cutting of materials with cyclic deformation. The formation and trajectory of these metal chips are influenced by several factors, including the cutting parameters, material properties, and the forces acting on the chips. The primary forces affecting the trajectory of metal chips are the cutting force exerted by the tool and the force of gravity.

The cutting force is the result of the interaction between the cutting tool and the workpiece. It can be decomposed into three components: the tangential force (Fc), the axial force (Fa), and the radial force (Fr). The tangential force is directed along the cutting direction and is the largest of the three components. The axial force is parallel to the axis of the workpiece, and the radial force is perpendicular to the workpiece's surface. The magnitude and direction of these forces depend on the cutting parameters, such as speed, feed rate, and depth of cut, as well as the material properties of the workpiece. The force of gravity acts downward on the metal chips, influencing their trajectory as they are ejected from the cutting zone. The combined effect of the cutting force and gravity determines the path that the chips will follow. For example, continuous chips may curl and form spirals due to the tangential force, while discontinuous chips may be ejected in a more straightforward manner.

The simulation and adjustment module 215 is configured to use real-time data from sensors 214 to monitor the cutting forces and chip formation patterns. Machine learning algorithms, trained on historical data, predict the formation and trajectory of the metal chips based on the current cutting conditions. The simulation and adjustment module 215 simulates different cutting scenarios to determine the optimal alignment of the cutting tool and workpiece, ensuring that the chips are directed away from the finished surface. For instance, if the model predicts that continuous chips will form and potentially contact the finished workpiece, the module can adjust the cutting speed, feed rate, or tool orientation to produce discontinuous chips that are easier to remove. The simulation and adjustment module 215 can also simulate the effects of different cutting fluid applications and chip removal strategies, such as suction for discontinuous chips or trimming for continuous chips, to ensure that the chips do not interfere with the finished surface. By continuously monitoring the real-time data and updating the predictions, the simulation and adjustment module 215 dynamically adjusts the cutting parameters to control the trajectory of the metal chips. This approach ensures precise and damage-free machining by adapting to the real-time conditions of the cutting process and preventing chips from contacting the finished workpiece.

In exemplary embodiments, the system 200 also includes an electromagnet 226 that is configured to selectively generates a magnetic field to influence the trajectory of the metal chips 224. The electromagnet 226 is controlled by the control system 210 and can be adjusted to create a magnetic or static electricity field. This field helps to direct the metal chips 224 away from the finished workpiece, ensuring a clean and precise cut. The electromagnet positioning actuator(s) 228 is configured to adjust the position and orientation of the electromagnet 226. These actuators ensure that the magnetic field is applied in the optimal direction to control the trajectory of the metal chips 224. The electromagnet positioning actuator(s) 228 receives commands from the control system 210 and makes real-time adjustments based on the actual chip formation patterns observed during the cutting operation.

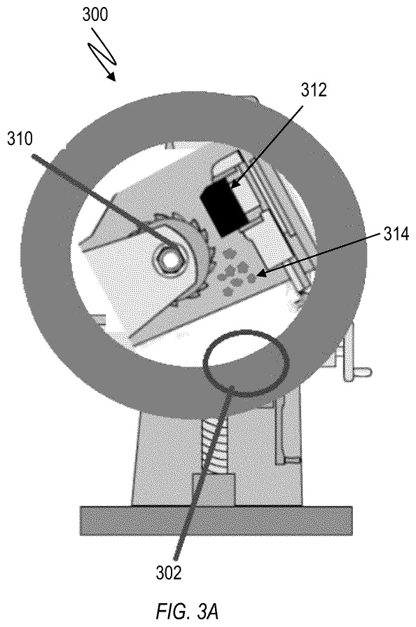

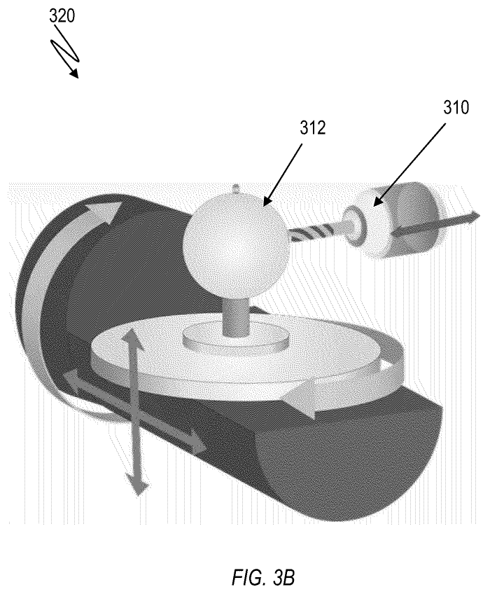

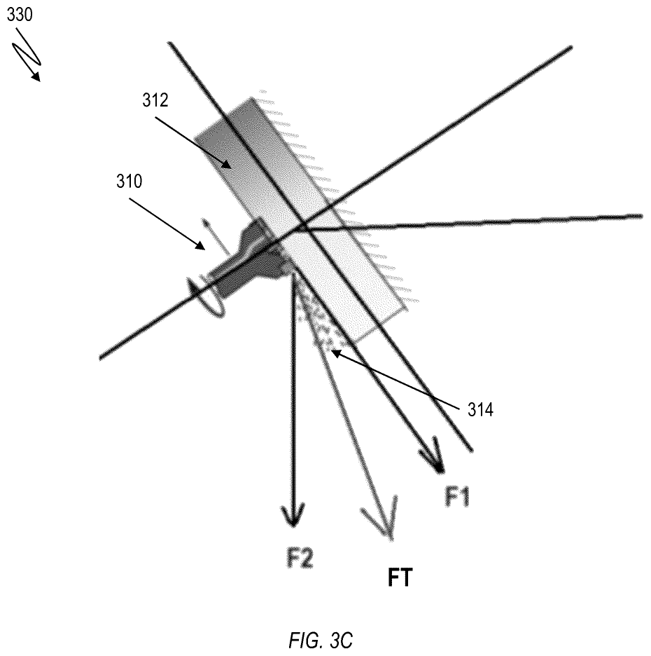

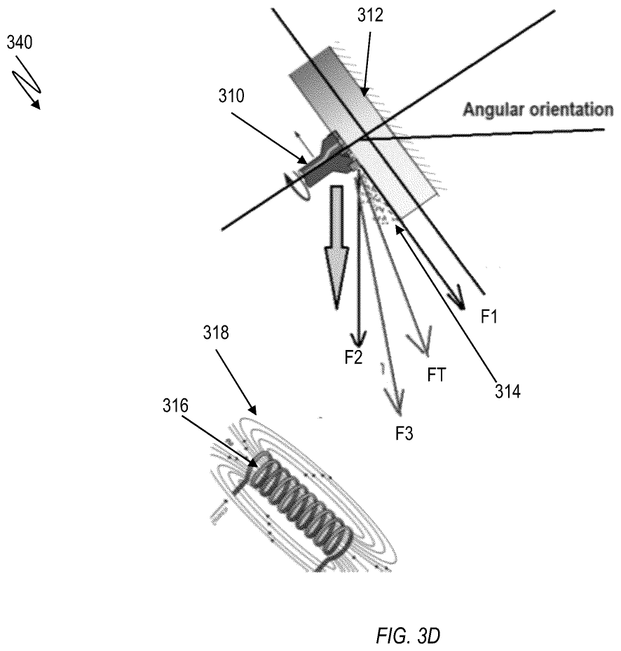

FIG. 3A shows a system 300 for controlling the trajectory of metal chips during a metal cutting operation. The system 300 includes a rotating arm 302, a cutting tool 310, a workpiece 312, and metal chips 314. The rotating arm 302 supports and positions the cutting tool 310. The rotating arm 302 allows for precise adjustments in the orientation and position of the cutting tool 310 during the cutting operation. The rotating arm 302 ensures that the cutting tool 310 is aligned correctly to minimize chip contact with the finished workpiece 312. The cutting tool 310 performs the actual cutting operation on the workpiece 312. The cutting tool 310 is controlled by the rotating arm 302 and is adjusted based on the predicted and actual chip formation patterns. The cutting tool 310's orientation and movement ensure that metal chips 314 do not contact the finished workpiece 312. The workpiece 312 is the material being machined by the cutting tool 310. The workpiece 312's position and orientation are adjusted by the rotating arm 302 to optimize the cutting process and prevent chip contact. The workpiece 312's dimensions and material properties are considered by the control system to determine the cutting strategy. The metal chips 314 are the byproducts of the cutting operation. The system 300 predicts the formation and trajectory of the metal chips 314 to prevent them from contacting the finished workpiece 312. The system 300 dynamically adjusts the cutting parameters to control the flow of metal chips 314.

In the embodiment shown in FIG. 3A, the system is designed to rotate the direction of the cutting tool 310 and a workpiece 312 to optimize the metal cutting operation. This capability allows for precise adjustments to the orientation of both the cutting tool and the workpiece, ensuring that metal chips are effectively controlled and do not contact the finished workpiece. In one embodiment, the cutting tool is equipped with a rotating cutting tool holder, which includes a mechanism to rotate the cutting tool holder around the Z-axis, typically the axis perpendicular to the workpiece surface. This rotation can be achieved using a rotary table or a rotary axis attachment. The rotation of the tool holder is controlled by a step motor or servo motor attached to the rotary axis. This motor receives commands from the control system to rotate the cutting tool holder to the desired angle. With current capabilities, the tool can perform different directional rotations, allowing for versatile machining operations. Similarly, a workpiece gripping platform is designed to rotate. It can be a rotary table or chuck capable of holding and rotating the workpiece. The rotation of the workpiece gripping platform is also controlled by a step motor or servo motor attached to the rotary axis. This motor receives commands from the control system to rotate the workpiece to the desired angle. The step motors or servo motors controlling the rotation of both the cutting tool holder and the workpiece gripping platform are integrated with the control system. This embodiment allows the control system to dynamically adjust the orientation of the cutting tool and workpiece based on real-time data and predictions of metal chip formation patterns. By rotating the cutting tool holder and workpiece gripping platform, the control system can optimize the cutting process, prevent metal chips from contacting the finished workpiece, and enhance the overall performance and quality of the machining operation.

FIG. 3B shows a portion of a system for controlling the trajectory of metal chips during a metal cutting operation. The system includes a 5-axis tool 320, a cutting tool 310, and a workpiece 312. The 5-axis tool 320 supports and positions the cutting tool 310. The 5-axis tool 320 allows for precise adjustments in the orientation and position of the cutting tool 310 during the cutting operation. The 5-axis tool 5AT 320 ensures that the cutting tool 310 is aligned correctly to minimize chip contact with the finished workpiece 312. The cutting tool 310 performs the actual cutting operation on the workpiece 312. The cutting tool 310 is controlled by the 5-axis tool 320 and is adjusted based on the predicted and actual chip formation patterns. The cutting tool 310's orientation and movement ensure that metal chips do not contact the finished workpiece 312. In exemplary embodiments, the 5-axis tool 320 may be used in conjunction with the system 300 shown in FIG. 3A.

FIG. 3C shows a system 330 for controlling the trajectory of metal chips during a metal cutting operation. The system 330 includes a cutting tool 310, a workpiece 312, and metal chips 314. The cutting tool 310 performs the actual cutting operation on the workpiece 312. The cutting tool 310 is positioned and oriented to minimize chip contact with the finished workpiece 312. The cutting tool 310's orientation and movement ensure that metal chips 314 do not contact the finished workpiece 312. The workpiece 312 is the material being machined by the cutting tool 310. The workpiece 312's position and orientation are adjusted to optimize the cutting process and prevent chip contact. The workpiece 312's dimensions and material properties are considered by the system 330 to determine the cutting strategy. The metal chips 314 are the byproducts of the cutting operation. As illustrated, force F1 represents the cutting force applied on the generated metal chips 314 and force F2 represents the gravitational force acting on the metal chips 314. These forces influence the trajectory of the metal chips 314 during the cutting operation. In exemplary embodiments, these forces are monitors and the orientation of the workpieces 312 and/or the tool 310 are adjusted to ensure the metal chips 314 are directed away from the finished workpiece 312. As illustrated, force F1 represents the cutting force applied on the generated metal chips 314 and force F2 represents the gravitational force acting on the metal chips 314. In exemplary embodiments, these forces, F1 and F2 combine to create an overall effective force FT that determines the trajectory of the metal chips 314.

FIG. 3D shows a system 340 for controlling the trajectory of metal chips during a metal cutting operation. The system 340 includes a cutting tool 310, a workpiece 312, metal chips 314, an electromagnet 316, and an electromagnetic field 318. The system 340 is similar to the system 330 shown in FIG. 3C but also includes an electromagnet 316 that is configured to generate an electromagnetic field 318 to influence the trajectory of the metal chips 314. The electromagnet 316 is controlled by the control system and can be adjusted to create the electromagnetic field 318. This field helps to direct the metal chips 314 away from the finished workpiece 312, ensuring a clean and precise cut. In exemplary embodiments, the electromagnetic field 318 is applied in the optimal direction to control the trajectory of the metal chips 314. The system 340 dynamically adjusts the electromagnetic field 318 based on the actual chip formation patterns observed during the cutting operation.

In exemplary embodiments, the control system is configured to control the trajectory of the metal chips 314 by adjusting an orientation of the cutting tool 310 and the workpiece 312, and the operation of the electromagnet 316 As illustrated, force F1 represents the cutting force applied on the generated metal chips 314, force F2 represents the gravitational force acting on the metal chips 314, and force F3 represents the force exerted by the electromagnetic field 318 on the metal chips. In exemplary embodiments, these forces, F1, F2, and F3 combine to create an overall effective force FT that determines the trajectory of the metal chips 314.

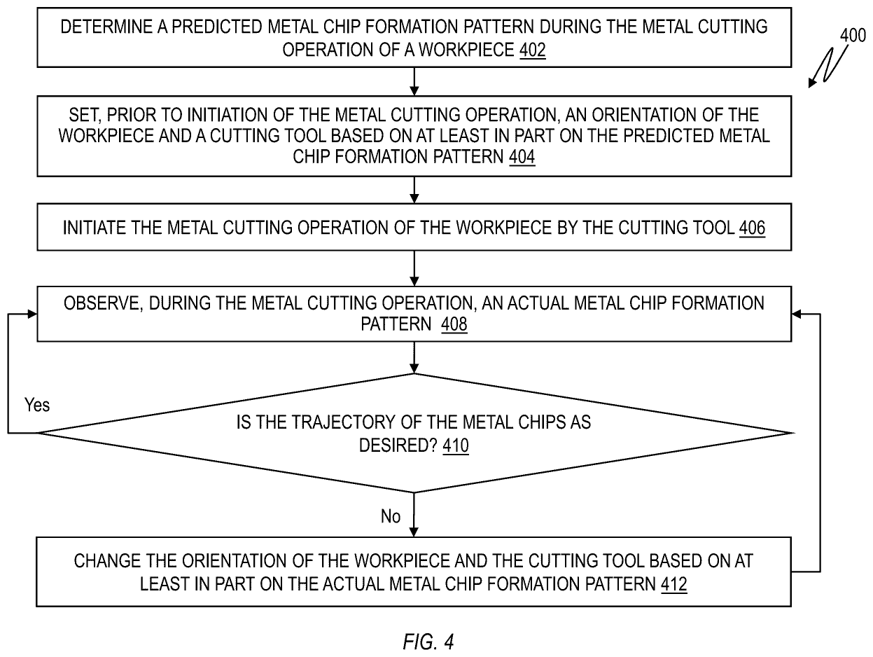

Referring now to FIG. 4, a flow chart illustrating a method 400 for controlling the trajectory of metal chips during a metal cutting operation is shown. In exemplary embodiments, the method 400 can be implemented by the system 200 as described in FIG. 2, which includes the control system 210, user interface 211, processor(s) 212, memory 213, sensor(s) 214, simulation and adjustment module 215, tool positioning actuator(s) 216, workpiece positioning actuator(s) 218, cutting tool 220, workpiece 222, metal chips 224, electromagnet 226, and electromagnet positioning actuator(s) 228.

The first step in the method 400 is to determine a predicted metal chip formation pattern during the metal cutting operation of a workpiece, as shown at block 402. In exemplary embodiments, the control system 210, in conjunction with the simulation and adjustment module 215, predicts the metal chip formation patterns based on historical data, real-time sensor input, and user input regarding the cutting operation and the workpiece. The simulation and adjustment module 215 may use machine learning algorithms trained on historical data to predict the formation and trajectory of the metal chips 224. This prediction is based on the current cutting conditions, including the position and movement of the cutting tool 220 and workpiece 222, the cutting forces, temperature, and vibrations.

Next, as shown at block 404, the method includes setting, prior to initiation of the metal cutting operation, an orientation of the workpiece and a cutting tool based on at least in part on the predicted metal chip formation pattern. The control system 210, using the simulation and adjustment module 215, determines the optimal alignment of the cutting tool 220 and workpiece 222 to control the trajectory of the metal chips 224. The tool positioning actuator(s) 216 and workpiece positioning actuator(s) 218 adjust the position and orientation of the cutting tool 220 and workpiece 222, respectively, to ensure that the metal chips 224 do not contact the finished portion of the workpiece 222.

The method 400 also includes initiating the metal cutting operation of the workpiece by the cutting tool, as shown at block 406. The cutting tool 220, controlled by the tool positioning actuator(s) 216, performs the actual cutting operation on the workpiece 222. The control system 210 continuously monitors the cutting process through the sensor(s) 214, which collect real-time data on various aspects of the operation, including the position of the cutting tool 220, the workpiece 222, and the formation of metal chips 224.

During the metal cutting operation, the method 400 includes observing an actual metal chip formation pattern, as shown at block 408. The sensor(s) 214 provides real-time feedback to the control system 210, enabling the control system 210 to observe the actual metal chip formation pattern. At decision block 410, the method includes comparing the actual metal chip formation pattern with the predicted pattern to determine if any adjustments are necessary to control the trajectory of the metal chips 224.

If the trajectory of the metal chips is not as desired, the control system 210 changes the orientation of one or more of the workpiece 222 and the cutting tool 220 based on at least in part on the actual metal chip formation pattern 412. The control system 210 dynamically adjusts the cutting parameters, including the alignment of the cutting tool 220 and workpiece 222, to control the trajectory of the metal chips 224. The tool positioning actuator(s) 216 and workpiece positioning actuator(s) 218 make real-time adjustments based on the sensor data and simulation results to ensure that the metal chips 224 do not contact the finished portion of the workpiece 222.

In exemplary embodiments, the method may also include controlling an electromagnet to create a magnetic or static electricity field, prior to initiation of the metal cutting operation, wherein the magnetic or static electricity field is configured to adjust the trajectory of the metal chips. The electromagnet 226, controlled by the control system 210, generates a magnetic or static electricity field to influence the trajectory of the metal chips 224. The electromagnet positioning actuator(s) 228 adjusts the position and orientation of the electromagnet 226 to ensure that the magnetic field is applied in the optimal direction to control the trajectory of the metal chips 224. The control system 210 further instructs the electromagnet to change the magnetic or static electricity field based on at least in part on the actual metal chip formation pattern. The control system 210 dynamically adjusts the magnetic or static electricity field generated by the electromagnet 226 based on the real-time observations of the actual metal chip formation pattern. This ensures that the metal chips 224 are directed away from the finished workpiece 222, maintaining a clean and precise cut.

In one embodiment, the cutting tool 220 is equipped with an advanced control system that dynamically adjusts the direction and speed of the cutting fluid application based on real-time adjustments made to the cutting operation orientation. This ensures that metal chips are effectively prevented from contacting the workpiece, and the cutting operation is carried out efficiently with optimal utilization of the cutting fluid. During the metal cutting operation, the control system 210 of the cutting tool 220 continuously monitors the cutting process using various sensors that collect real-time data on the position and movement of the cutting tool and workpiece, the cutting forces, temperature, and chip formation patterns. The control system 210 uses this data to predict the formation and trajectory of metal chips and dynamically adjusts the alignment of the cutting tool and workpiece to prevent chip contact with the finished workpiece. As the cutting tool and workpiece alignment is adjusted, the control system simultaneously recalculates the optimal direction and speed of the cutting fluid application. For example, if the cutting tool is reoriented to a new angle to minimize chip contact, the control system adjusts the cutting fluid nozzles to direct the fluid precisely at the new cutting zone. This ensures that the cutting fluid effectively cools and lubricates the cutting area, reducing heat and friction.

The method may also include determining the direction and speed of a cutting fluid applied by the cutting tool based on at least in part on the predicted metal chip formation pattern. The control system 210, using the simulation and adjustment module 215, calculates the optimal direction and speed of the cutting fluid to be applied during the cutting operation. The cutting fluid helps to cool and lubricate the cutting process, reducing the risk of metal chips 224 contacting the finished workpiece 222. The system adjusts one or more of the direction and speed of the cutting fluid applied by the cutting tool based on at least in part on the actual metal chip formation pattern. The control system 210 continuously monitors the cutting process and dynamically adjusts the cutting fluid parameters to ensure optimal performance. This includes changing the direction and speed of the cutting fluid to prevent metal chips 224 from contacting the finished workpiece 222.

In exemplary embodiments, the predicted metal chip formation pattern is determined based on a simulation of the cutting tool performing the metal cutting operation on the workpiece. The simulation and adjustment module 215 uses historical data and real-time sensor input to simulate different cutting scenarios and predict the metal chip formation patterns. This simulation helps to determine the optimal alignment of the cutting tool 220 and workpiece 222 to control the trajectory of the metal chips 224.

In exemplary embodiments, the control system 210 can update a prediction model utilized by the simulation and adjustment module 215 based on the monitored trajectory of metal chips by incorporating real-time data and feedback into the machine learning algorithms used for predicting chip formation patterns. During the metal cutting operation, the control system 210 continuously collects real-time data from various sensors 214 that monitor the position and movement of the cutting tool and workpiece, the cutting forces, temperature, vibrations, and the actual trajectory of the metal chips. Optical sensors, such as machine vision cameras, provide visual data on chip formation and movement. The collected data is analyzed to identify any discrepancies between the predicted and actual chip trajectories. The control system 210 compares the real-time observations with the predictions made by the existing model, noting any deviations or patterns in the chip movement as feedback for updating the model. The control system 210 uses this feedback to retrain the machine learning model, feeding the real-time data along with historical data into the model to improve its accuracy. The model learns from the new data, adjusting its parameters and algorithms to better predict chip formation patterns and trajectories under similar cutting conditions in the future. This process of data collection, analysis, and model updating forms a continuous learning loop, allowing the system to continuously refine its predictions as it encounters new cutting scenarios and materials. The updated prediction model is integrated with the simulation and adjustment module 215, which uses the improved model to make real-time adjustments to the cutting parameters, such as tool alignment, cutting speed, feed rate, and cutting fluid application. This integration ensures that the system can dynamically respond to changing conditions and maintain optimal cutting performance. To ensure the reliability of the updated model, the system periodically validates and verifies its predictions against actual cutting operations by running controlled tests and comparing the predicted chip trajectories with the observed results. Any discrepancies are further analyzed, and the model is fine-tuned as needed. By continuously updating the prediction model based on the monitored trajectory of metal chips, the control system 210 can maintain high accuracy and adapt to new cutting conditions, enhancing the overall efficiency and quality of the metal cutting operation and ensuring precise and damage-free machining.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for controlling a trajectory of metal chips during a metal cutting operation, the method comprising:
determining a predicted metal chip formation pattern during the metal cutting operation of a workpiece;
setting, prior to initiation of the metal cutting operation, an orientation of the workpiece and a cutting tool based on at least in part on the predicted metal chip formation pattern;
initiating the metal cutting operation of the workpiece by the cutting tool;
observing, during the metal cutting operation, an actual metal chip formation pattern; and
changing the orientation of the workpiece and the cutting tool based on at least in part on the actual metal chip formation pattern,
wherein the orientation of the workpiece and the cutting tool are configured to control the trajectory of the metal chips to prevent the metal chips from contacting a finished portion of the workpiece.

2. The computer-implemented method of claim 1, further comprising controlling an electromagnet to create a magnetic or static electricity field, prior to initiation of the metal cutting operation, wherein the magnetic or static electricity field is configured to adjust the trajectory of the metal chips.

3. The computer-implemented method of claim 2, further comprising instructing the electromagnet to change the magnetic or static electricity field based on at least in part on the actual metal chip formation pattern.

4. The computer-implemented method of claim 1, further comprising determining a direction and speed of a cutting fluid applied by the cutting tool based on at least in part on the predicted metal chip formation pattern.

5. The computer-implemented method of claim 4, further comprising adjusting one or more of the direction and speed of the cutting fluid applied by the cutting tool based on at least in part on the actual metal chip formation pattern.

6. The computer-implemented method of claim 1, wherein the predicted metal chip formation pattern is determined based on a simulation of the cutting tool performing the metal cutting operation on the workpiece.

7. The computer-implemented method of claim 1, wherein the orientation of the workpiece and the cutting tool is changed based on a difference between the actual metal chip formation pattern and the predicted metal chip formation pattern.

8. A system comprising:
a memory comprising computer readable instructions; and
a processing device for executing the computer readable instructions, the computer readable instructions controlling the processing device to perform operations comprising:
determining a predicted metal chip formation pattern during a metal cutting operation of a workpiece;
setting, prior to initiation of the metal cutting operation, an orientation of the workpiece and a cutting tool based on at least in part on the predicted metal chip formation pattern;
initiating the metal cutting operation of the workpiece by the cutting tool;
observing, during the metal cutting operation, an actual metal chip formation pattern; and
changing the orientation of the workpiece and the cutting tool based on at least in part on the actual metal chip formation pattern,
wherein the orientation of the workpiece and the cutting tool are configured to control a trajectory of the metal chips to prevent the metal chips from contacting a finished portion of the workpiece.

9. The system of claim 8, wherein the operations further comprise controlling an electromagnet to create a magnetic or static electricity field, prior to initiation of the metal cutting operation, wherein the magnetic or static electricity field is configured to adjust the trajectory of the metal chips.

10. The system of claim 9, wherein the operations further comprise instructing the electromagnet to change the magnetic or static electricity field based on at least in part on the actual metal chip formation pattern.

11. The system of claim 8, wherein the operations further comprise determining a direction and speed of a cutting fluid applied by the cutting tool based on at least in part on the predicted metal chip formation pattern.

12. The system of claim 11, wherein the operations further comprise adjusting one or more of the direction and speed of the cutting fluid applied by the cutting tool based on at least in part on the actual metal chip formation pattern.

13. The system of claim 8, wherein the predicted metal chip formation pattern is determined based on a simulation of the cutting tool performing the metal cutting operation on the workpiece.

14. The system of claim 8, wherein the orientation of the workpiece and the cutting tool is changed based on a difference between the actual metal chip formation pattern and the predicted metal chip formation pattern.

15. A computer program product for controlling a trajectory of metal chips during a metal cutting operation, the computer program product comprising:
a set of one or more computer-readable storage media;
program instructions, collectively stored in the set of one or more storage media, for causing a processor set to perform the following computer operations:
determining a predicted metal chip formation pattern during the metal cutting operation of a workpiece;
setting, prior to initiation of the metal cutting operation, an orientation of the workpiece and a cutting tool based on at least in part on the predicted metal chip formation pattern;
initiating the metal cutting operation of the workpiece by the cutting tool;
observing, during the metal cutting operation, an actual metal chip formation pattern; and
changing the orientation of the workpiece and the cutting tool based on at least in part on the actual metal chip formation pattern,
wherein the orientation of the workpiece and the cutting tool are configured to control a trajectory of the metal chips to prevent the metal chips from contacting a finished portion of the workpiece.

16. The computer program product of claim 15, wherein the operations further comprise controlling an electromagnet to create a magnetic or static electricity field, prior to initiation of the metal cutting operation, wherein the magnetic or static electricity field is configured to adjust the trajectory of the metal chips.

17. The computer program product of claim 16, wherein the operations further comprise instructing the electromagnet to change the magnetic or static electricity field based on at least in part on the actual metal chip formation pattern.

18. The computer program product of claim 15, wherein the operations further comprise determining a direction and speed of a cutting fluid applied by the cutting tool based on at least in part on the predicted metal chip formation pattern.

19. The computer program product of claim 18, wherein the operations further comprise adjusting one or more of the direction and speed of the cutting fluid applied by the cutting tool based on at least in part on the actual metal chip formation pattern.

20. The computer program product of claim 15, wherein the predicted metal chip formation pattern is determined based on a simulation of the cutting tool performing the metal cutting operation on the workpiece.
